(19) United States
(12) Patent Application Publication
(10) Pub. No.: US 2008/0168857 A1
(43) Pub. Date: Jul. 17, 2008

(54) Bicycle handle device

(76) Inventor: Douglas Chiang, Taichung City (TW)

Correspondence Address: DOUGLAS CHIANG, 235 Chung - Ho, Box 8-24, Taipei, omitted

(21) Appl. No.: 11/653,457

(22) Filed: Jan. 16, 2007

(51) Int. Cl. B62K 21/12

(52) U.S. Cl. 74/551.1

(57) ABSTRACT

A bicycle handle device comprises a combining portion having a round cylindrical shape; each of two ends of the combining portion being extended with an inclined wing; one end of the wing far away from the combining portion being installed with a handle; each connection of the combining portion and the wing being extended with an auxiliary handle; each auxiliary handle being approximately vertical to the combining portion; a front end of each auxiliary handle far away from the combining portion being bent upwards; a length of the combining portion being approximately equal to that of each wing; a stand tube of a bicycle can be movably installed to the combining portion; the lengths of two auxiliary handles being approximately equal; and a connection of the combining portion and the auxiliary handle being installed with a seat for supporting a cambered supporting plate which has a sheet like structure.

### FIELD OF THE INVENTION

The present invention relates to bicycles, and particularly to a bicycle handle device, wherein two auxiliary handles extended from the connections of the combining portion and two wings. The orientations of the auxiliary handles with respect to the stand tube assembled to the bicycle handle device are adjustable. Furthermore the combining portion, wings and auxiliary handles are integrally formed so that assembly work is simple and cost is low.

### BACKGROUND OF THE INVENTION

In the prior art bicycle structure, the bicycle has a handle device. The handle has a combining portion and a horizontal combining portion and two inclined wings extended from two ends of the combining portion. A length of each combining portion is approximately equal to that of each wing. The combining portion can be screwed to a stand tube of a bicycle. An auxiliary handle is installed to the stand tube by screwing. The elevation of the auxiliary handle is adjustable according to the height of the driver so as to have a comfortable driving position.

However, the prior art has the defects that the detachable auxiliary handle and the stand tube are adjustable, but the assembly work is difficult and the requirement elements are greater. Thus the cost is high. If the wings, stand tube and auxiliary handle are made integrally, the special shape will increase the difficulty in manufacturing and it is difficult to form the mold. Furthermore the structure only uses in special form bicycles. Moreover, the space for storing the elements is larger and the cost is thus increased.

### SUMMARY OF THE INVENTION

Accordingly, the primary object of the present invention is to provide a bicycle handle device, wherein two auxiliary handles extended from the connections of the combining portion and two wings. The orientations of the auxiliary handles with respect to the stand tube assembled to the bicycle handle device are adjustable. Furthermore the combining portion, wings and auxiliary handles are integrally formed so that assembly work is simple and cost is low.

To achieve above objects, the present invention provides a bicycle handle device comprising: a combining portion having a round cylindrical shape; each of two ends of the combining portion being extended with an inclined wing; one end of the wing far away from the combining portion being installed with a handle; each connection of the combining portion and the wing being extended with an auxiliary handle; each auxiliary handle being approximately vertical to the combining portion; a front end of each auxiliary handle far away from the combining portion being bent upwards; a length of the combining portion being approximately equal to that of each wing; a stand tube of a bicycle can be movably installed to the combining portion; the lengths of two auxiliary handles being approximately equal; and a connection of the combining portion and the auxiliary handle being installed with a seat for supporting a cambered supporting plate which has a sheet like structure; the supporting plate being screwed to the seat.

The various objects and advantages of the present invention will be more readily understood from the following detailed description when read in conjunction with the appended drawing.

### BRIEF DESCRIPTION OF THE DRAWINGS

FIG. 1 is an exploded schematic view of the bicycle handle device of the present invention.

FIG. 2 is a schematic view of the bicycle handle device of the present invention.

FIG. 3 is a schematic view of the present invention, where the handle device is assembled to a bicycle.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

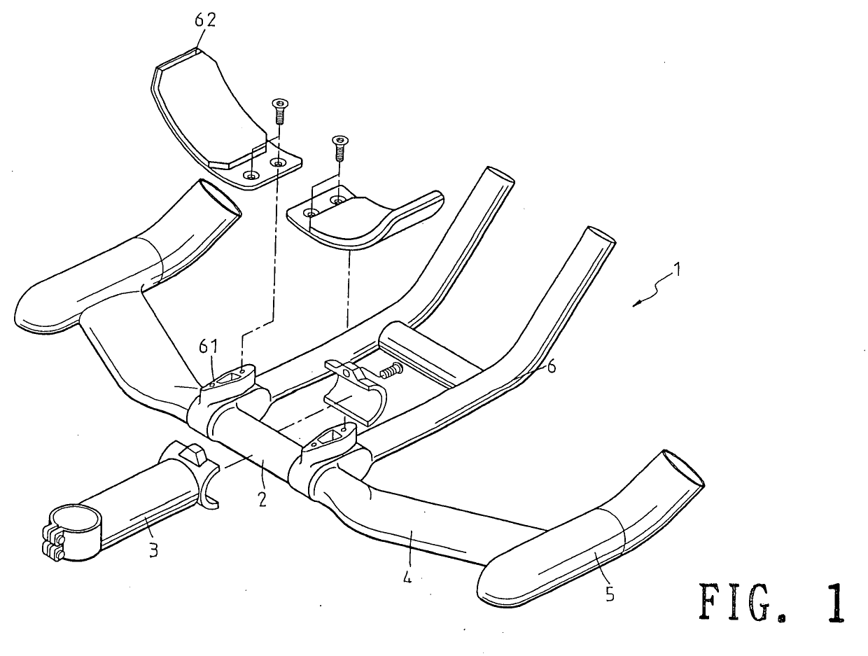

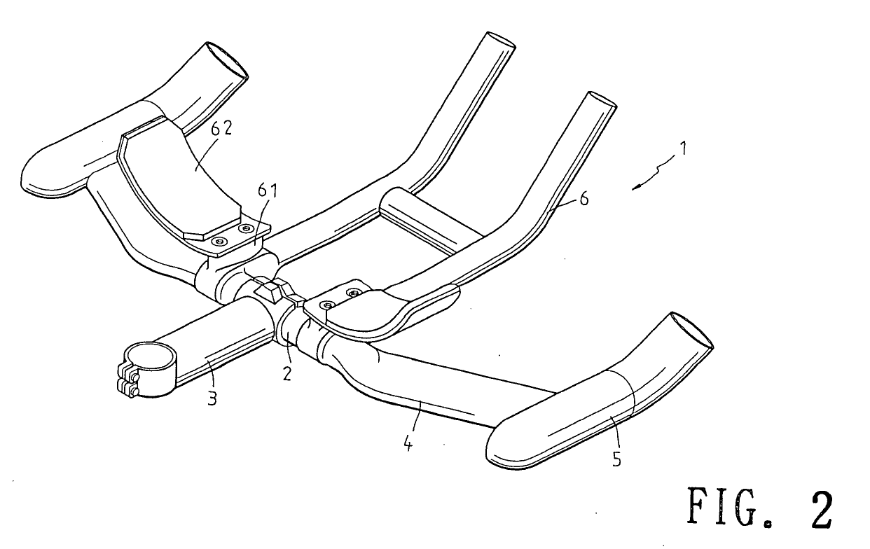

Referring to FIGS. 1 and 2, the bicycle handle device 1 of the present invention is illustrated. The present invention has the following elements.

A combining portion 2 has a round cylindrical shape. Each of two ends of the combining portion 2 is extended with an inclined wing 4. One end of the wing 4 far away from the combining portion 2 is installed with a handle 5. Each connection of the combining portion 2 and the wing 4 is extended with an auxiliary handle 6. Each auxiliary handle 6 is approximately vertical to the combining portion 2. A front end of each auxiliary handle 6 far away from the combining portion 2 is bent upwards.

A length of the combining portion 2 is approximately equal to that of each wing 4. A stand tube 3 of a bicycle 7 can be movably installed to the combining portion 2. The lengths of two auxiliary handles 6 are approximately equal. The user can hold the auxiliary handle 6 or the handle 5 as desired.

The connection of the combining portion 2 and the auxiliary handle 6 is formed as a seat 61 for supporting a cambered supporting plate 62 which has a sheet like structure. The supporting plate 62 is screwed to the seat 61. When the user holds the auxiliary handles 6, the elbows can place upon the supporting plates 62 so that the use will feel easy in driving the bicycle 7.

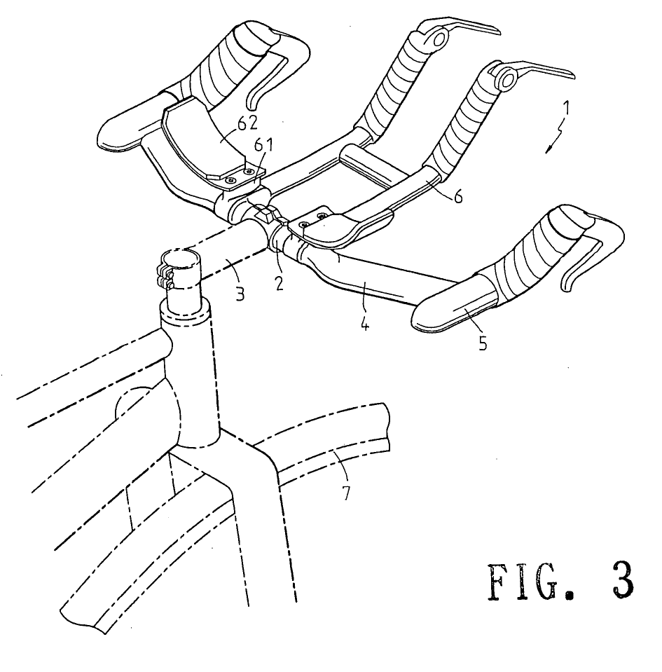

Referring to FIGS. 3, the assembly schematic view of the present invention is illustrated. When the user holds the auxiliary handles 6, the orientation of the auxiliary handle 6 with respect to the stand tube 3, and the orientation of the combining portion 2 with respect to the stand tube 3 are adjusted and the orientation of the auxiliary handle 6 with respect to the handle 5 is also adjustable. When the auxiliary handle 6 is lifted upwards to have a larger angle, the user can drive the bicycle 7 for a long time not to feel ache.

Moreover, in the present invention, the combining portion 2, wings 4 and auxiliary handles 6 are integrally formed. In manufacturing, few elements are necessary to be formed, while the function of adjusting orientation can be achieved. If the stand tube 3, combining portion 2, wings 4, and auxiliary handles 6 are integrally formed, although more element can be simplified, the manufacturing process is difficult. However, in the present invention, the function of change orientation is retained, and the cost can be saved greatly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle handle device comprising:
a combining portion;
two wings extended from two ends of the combining portion; one end of each wing far away from the combining portion being extended with a handle; each connection of the combining portion and each wing being extended with an auxiliary handle;
wherein the combining portion, wings, and auxiliary handles are integrally formed; an orientation of the auxiliary handles with respect to a stand tube assembled to the bicycle handle device is adjustable.

2. The bicycle handle device as claimed in claim 1, wherein the combining portion is assembled to a stand tube of a bicycle.

3. The bicycle handle device as claimed in claim 1, wherein each wing is inclined to the combining portion.

4. The bicycle handle device as claimed in claim 1, wherein the two wings are symmetrical to the combining portion and have an equal length.

5. The bicycle handle device as claimed in claim 1, wherein the two auxiliary handles have an equal length.

6. The bicycle handle device as claimed in claim 1, wherein each auxiliary handle is inclined to the combining portion.

7. The bicycle handle device as claimed in claim 1, wherein a seat is installed at an connection of the combining portion and the auxiliary handle.

8. The bicycle handle device as claimed in claim 7, wherein each seat is installed with a supporting plate at an upper side thereof.

9. A bicycle handle device comprising:
a combining portion having a round cylindrical shape; each of two ends of the combining portion being extended with an inclined wing; one end of the wing far away from the combining portion being installed with a handle; each connection of the combining portion and the wing being extended with an auxiliary handle; each auxiliary handle being approximately vertical to the combining portion; a front end of each auxiliary handle far away from the combining portion being bent upwards;
a length of the combining portion being approximately equal to that of each wing; a stand tube of a bicycle can be movably installed to the combining portion; the lengths of two auxiliary handles being approximately equal; and
a connection of the combining portion and the auxiliary handle being installed with a seat for supporting a cambered supporting plate which has a sheet like structure; the supporting plate being screwed to the seat.
